(19) United States
(12) Patent Application Publication
(10) Pub. No.: US 2004/0177257 A1
(43) Pub. Date: Sep. 9, 2004

(54) Data processing device and data processing method

(75) Inventors: Ikuko Fujinawa, Kyoto (JP); Toshio Higuchi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/790,711

(22) Filed: Mar. 3, 2004

(30) Foreign Application Priority Data
Mar. 3, 2003 (JP) 2003-055626

(51) Int. Cl. H04L 9/00

(52) U.S. Cl. 713/189

(57) ABSTRACT

In order to increase concealment of stored data without causing decryption-key management to become complicated, data blocks stored in a memory include execution blocks and decryption information sets. The execution blocks are obtained by dividing an original program into data sets, and then encrypting the divided data sets with respectively different key data sets. The decryption information sets include encrypted key data sets, each of which is used to decrypt the data block that will be read subsequently. When each data block is read into a microcomputer, the encrypted key data included in the decryption information is decrypted by a decryption portion, and then retained in a key-data temporary retention portion, before it is retained in a key data retention portion when the subsequent data block is read. The decrypted and retained key data decrypts the decryption information and execution block included in the next data block.

### BACKGROUND OF THE INVENTION

The present invention pertains to technology related to preventing data stored in memories, IC cards, hard disks, and other storage media from being leaked easily to a third party.

Techniques have been conventionally known in which data-encryption methods are used in order to prevent leakage, to a third party, of data stored in a storage medium such as a memory, in particular, of data as a program composed of a series of instruction codes that a CPU performs. More specifically, as disclosed in Japanese Laid-Open Publication No. 7-129473 (Japanese Patent No. 2576385), for example, known data protection devices which read data sets stored in storage media use encryption keys (decryption keys) to successively decrypt encrypted ones of the data sets that the devices have read from the storage media, and then input the resultant decrypted data sets into the CPU included in the devices. The encryption keys are permanently defined beforehand in the devices, or defined at will for each stored data set.

In those conventional devices, nevertheless, a single encryption key is used as the encryption key for decrypting the encrypted data. This causes a problem to arise in that leakage of that single encryption key as well as the decryption method (algorithm) leads to leakage of all data stored in the storage medium.

In order to prevent such leakage of all data, data to be stored in a storage medium might be divided into multiple blocks, and different encryption keys might be used to encrypt/decrypt the data in the respective blocks. This, however, requires the plurality of encryption keys to correspond to the respective blocks, which complicates encryption and decryption process as well as encryption-key management.

### SUMMARY OF THE INVENTION

In view of the above problem, it is therefore an object of the present invention to prevent data stored in a storage medium from being leaked easily to a third party, without complicating encryption-key management.

In order to solve the above problem, a first inventive data processing device, which reads and decrypts encrypted data sets and encrypted key data sets stored in a storage medium, the encrypted data sets being obtained by dividing to-be-stored data into a plurality of divided data sets and then encrypting at least part of the divided data sets for decryption by respectively different key data sets, each of the encrypted key data sets being obtained by encrypting each said key data set for decryption by any one of the other key data sets, includes: a read-control portion for controlling reading of each said encrypted data set and each said encrypted key data set; a decryption portion for decrypting the encrypted data set and the encrypted key data set that have been read under the control of the read-control portion; and a key-data retention portion that retains one of the key data sets that has been decrypted from the encrypted key data set by the decryption portion. The decryption portion is configured so as to decrypt the encrypted data set and the encrypted key data set based on one of the key data sets that has been already retained in the key-data retention portion.

In the first inventive data processing device, the divided data sets are encrypted for decryption by different key data sets. Therefore, should a part of the key data sets be leaked, the whole contents stored in the storage medium would not become known easily. Furthermore, each key data set is encrypted for decryption by any one of the other key data sets, and then stored in the storage medium. This eliminates the need for managing the plurality of key data sets, thus preventing the encryption key management to become complicated.

A second inventive data processing device is the first data processing device in which the read-control portion is configured so as to successively read, in a uniquely determined order, the encrypted data sets and the encrypted key data sets stored in the storage medium, the encrypted data sets being obtained by encrypting all of the divided data sets, the encrypted key data sets being obtained by encrypting the key data sets for decrypting the respective encrypted data sets; and the decryption portion is configured so as to decrypt, based on one of the key data sets that is retained in the key-data retention portion, a first one of the encrypted data sets and a first one of the encrypted key data sets read from the storage medium, and then output a first one of the divided data sets and a first one of the key data sets, and so as to decrypt, based on the first key data set decrypted and retained in the key-data retention portion, a second one of the encrypted data sets and a second one of the encrypted key data sets read following on the first encrypted data set and the first encrypted key data set.

In the second inventive device, the encrypted data sets and the encrypted key data sets stored in the storage medium are read in a given order, which allows each encrypted data set, and the encrypted key data set for decrypting the next encrypted data set to be read and decrypted successively. Accordingly, the original, pre-encryption data can be obtained easily.

A third inventive data processing device is the first inventive device, in which the read-control portion is configured so as to successively read, in a uniquely determined order, the encrypted data sets that are said encrypted ones of the plurality of divided data sets stored in the storage medium, non-encrypted data sets that are the other divided data sets that are stored in the storage medium without being encrypted, and the encrypted key data sets stored in the storage medium, the encrypted key data sets corresponding to the respective encrypted data sets and the respective non-encrypted data sets; and the decryption portion is configured in such a manner that when a first one of the encrypted key data sets and a first one of the encrypted data sets have been read from the storage medium, the decryption portion decrypts the first encrypted key data set and the first encrypted data set based on one of the key data sets that is retained in the key-data retention portion, and then outputs a first one of the divided data sets and a first one of the key data sets, that when the first encrypted key data set and a first one of the non-encrypted data sets have been read from the storage medium, on the other hand, the decryption portion decrypts the first encrypted key data set based on another one of the key data sets that is retained in the key-data retention portion, and then outputs the first key data set, and that the decryption portion decrypts, based on the first key data set, a second one of the encrypted key data sets, or the second encrypted key data set and a second one of the encrypted data sets, read following on the first encrypted key data set and the first encrypted data set, or following on the first encrypted key data set and the first non-encrypted data set.

In the third inventive device, the encrypted data sets and the non-encrypted data sets that are stored together in the storage medium are read, such that the required decryption operation can be minimized, thereby easily preventing a decrease in the read speed.

A fourth inventive data processing device is the first inventive device in which the read-control portion is configured so as to successively read, in a uniquely determined manner, the encrypted data sets that are said encrypted ones of the plurality of divided data sets stored in the storage medium, non-encrypted data sets that are the other divided data sets that are stored in the storage medium without being encrypted, and the encrypted key data sets stored in the storage medium, the encrypted key data sets corresponding to the respective encrypted data sets; and the decryption portion is configured in such a manner that when a first one of the encrypted key data sets and a first one of the encrypted data sets have been read from the storage medium, the decryption portion decrypts the first encrypted key data set and the first encrypted data set based on one of the key data sets that is retained in the key-data retention portion, and then outputs a first one of the divided data sets and a first one of the key data sets, and that the decryption portion decrypts, based on the first key data set, a second one of the encrypted key data sets and a second one of the encrypted data set sets read after the first encrypted key data set and the first encrypted data set.

In the fourth inventive device, each key data set is used to decrypt the subsequently read encrypted data set, and the encrypted key data corresponding to that subsequent encrypted data set. There need not to decrypt any encrypted key data corresponding to the non-encrypted data. It is thus possible to further prevent a decrease in the read speed, and to lessen the amount of increase in the stored data.

A fifth inventive data processing device is the first inventive device in which the read control portion is configured so as to read, after reading a first one of the encrypted data sets stored in the storage medium, a second one or any one of second ones of the encrypted data sets which have each been determined beforehand to correspond to the first encrypted data set, and which form a possible-successor group, and so as to read, in relation to the first encrypted data set, an encrypted-key-data group that includes one or more of the encrypted key data sets which have been obtained by encrypting one or more of the key data sets, the one or more key data sets being used for decrypting the second encrypted data set or sets forming the possible-successor group; the key-data retention portion retains the one or more key data sets that have been decrypted from the one or more encrypted key data sets forming the encrypted-key-data group that has been read from the storage medium; and the decryption portion is configured so as to decrypt, based on one key data set that is included among the one or more key data sets retained in the key-data retention portion and that corresponds to the second encrypted data set that has been actually read following on the first encrypted data set, the second encrypted data set and at least one of the encrypted key data sets which has been read in accordance with the second encrypted data set, and which forms an encrypted-key-data group.

In the fifth inventive device, even if the encrypted data sets are not read in a certain order due to execution of a conditional branch instruction, for example, key data sets for decrypting those encrypted data sets that have a chance of being read next after each encrypted data set are decrypted and retained. Therefore, decryption can be properly performed in reading any of the encrypted data sets, which allows the encrypted data sets to be read in a flexible sequence. Accordingly, the data to be stored in the storage medium can be prepared and divided flexibly.

A sixth inventive data processing device is the first inventive device in which the data to be stored in the storage medium includes instructions that the data processing device is made to execute, and branch instructions included among those instructions determine a sequence of reading the encrypted data sets.

In the sixth inventive device, program modules and other data that are successively read by execution of the branch instructions can be protected using different key data sets.

A seventh inventive data processing device, which reads and decrypts encrypted data sets and encrypted key data sets stored in a storage medium, the encrypted data sets being obtained by dividing to-be-stored data into a plurality of divided data sets and then encrypting at least some of the divided data sets for decryption by respectively different key data sets, the encrypted key data sets being obtained by encrypting the key data sets for decryption by a common key data set, includes: a read-control portion for controlling reading of each said encrypted data set and each said encrypted key data set; a decryption portion for decrypting the encrypted data set and the encrypted key data set that have been read under the control of the read-control portion; and a key-data retention portion that retains the common key data set, and one of the key data sets decrypted from the encrypted key data, set by the decryption portion. The decryption portion is configured so as to decrypt the encrypted data set and the encrypted key data set based on one of the key data sets or the common key data set retained in the key-data retention portion.

In the seventh inventive data processing device, the encrypted key data sets are decrypted by the common key data, which permits the encrypted key data sets to be decrypted independently of the sequence of reading the encrypted data sets and the encrypted key data sets. Therefore, the encrypted data sets can be read in a flexible sequence.

An eighth inventive data processing device is the seventh inventive device in which the key data retention portion includes a first key-data retention portion for retaining the key data set decrypted from the encrypted key data set, and a second key data-retention portion for retaining the common key data set; and the decryption portion includes a first decryption portion for decrypting the encrypted data set based on the key data set retained in the first key data retention portion, and a second decryption portion for decrypting the encrypted key data set based on the common key data set retained in the second key data retention portion.

The eighth inventive device is provided with different key-data retention portions and decryption portions for decrypting the encrypted data sets and the encrypted key data sets, such that the encrypted data sets and the encrypted key data sets can be decrypted using different algorithms. Therefore, encryption strength and read speed can be easily well-balanced, for example.

A ninth inventive data processing device is the eighth inventive device that further includes a dummy-read-signal outputting portion that outputs a signal to the storage medium during the period in which the second decryption portion decrypts the encrypted key data set, the signal being the same as a signal for reading a data set stored in an area different from an area in which a data set that will be read next is stored.

In the ninth inventive data processing device, even in a case where decryption process for decoding each encrypted key data causes a delay in the reading of the next data that will be decrypted with the resultant key data obtained by that decryption process, signals such as dummy address signals based on random numbers, for example, are outputted. Those signals make it difficult to deduce from without with respect to the data processing device that the decryption process for the encrypted key data is being performed. Accordingly, it becomes more difficult for a malicious person to obtain the stored contents through analysis.

A first inventive data processing method, in which encrypted data sets and encrypted key data sets stored in a storage medium are read and decrypted, the encrypted data sets being obtained by dividing to-be-stored data into a plurality of divided data sets and then encrypting at least some of the divided data sets for decryption by respectively different key data sets, each of the encrypted key data sets being obtained by encrypting each said key data set for decryption by any one of the other key data sets, includes the steps of: (a) reading one of the encrypted data sets and one of the encrypted key data sets; and (b) decrypting said one encrypted data set and said one encrypted key data set that have been read in the step (a), and then making a key-data retention portion retain one of the key data sets that has been decrypted from said one encrypted key data set. In the step (b), said one encrypted data set and said one encrypted key data set are decrypted based on one of the key data sets that has already been retained in the key-data retention portion.

A second inventive data processing method, in which encrypted data sets and encrypted key data sets stored in a storage medium are read and decrypted, the encrypted data sets being obtained by dividing to-be-stored data into a plurality of divided data sets and then encrypting at least some of the divided data sets for decryption by respectively different key data sets, the encrypted key data sets being obtained by encrypting the key data sets for decryption by a common key data set, includes the steps of: (a) reading one of the encrypted data sets and one of the encrypted key data sets; and (b) decrypting said one encrypted data set and said one encrypted key data set that have been read in the step (a), and then making a key-data retention portion retain one of the key data sets that has been decrypted from said one encrypted key data set. In the step (b), said one encrypted data set and said one encrypted key data set are decrypted based on one of the key data sets or the common key data set that has already been retained in the key-data retention portion.

According to these inventive method, concealment of the stored contents can be also easily increased without causing key-data management to become complicated, as explained with respect to the first and seventh inventive data processing devices.

### BRIEF DESCRIPTION OF THE DRAWINGS

FIG. 1 is a block diagram illustrating the configuration of the main part of a microcomputer 100 in accordance with a first embodiment of the present invention.

FIG. 2 illustrates an exemplary content stored in a memory 120 in accordance with the first embodiment.

FIG. 3 illustrates an exemplary data configuration of a data block 201 in accordance with the first embodiment.

FIG. 4 is a flow chart illustrating exemplary procedural steps in which data is stored in the memory 120 in accordance with the first embodiment.

FIG. 5 is a flow chart illustrating how a program stored in the memory 120 is read and executed by the microcomputer 100 in accordance with the first embodiment.

FIG. 6 is a block diagram illustrating the configuration of the main part of a microcomputer 300 in accordance with a second embodiment of the present invention.

FIG. 7 illustrates an exemplary content retained in a key table 306a in accordance with the second embodiment.

FIG. 8 illustrates an exemplary data configuration of a data block 401 in accordance with the second embodiment.

FIG. 9 illustrates exemplary data-block branch instructions in instruction codes in accordance with the second embodiment.

FIG. 10 is a flow chart illustrating exemplary procedural steps in which data is stored in the memory 120 in accordance with the second embodiment.

FIG. 11 is a flow chart illustrating how a program stored in the memory 120 is read and executed by the microcomputer 300 in accordance with the second embodiment.

FIG. 12 illustrates an exemplary data configuration of a data block 701 in accordance with a third embodiment of the present invention.

FIG. 13 is a block diagram illustrating the configuration of the main part of a microcomputer 600 in accordance with the third embodiment.

FIG. 14 is a flow chart illustrating exemplary procedural steps in which data is stored in the memory 120 in accordance with the third embodiment.

FIG. 15 is a flow chart illustrating how a program stored in the memory 120 is read and executed by the microcomputer 600 in accordance with the third embodiment.

FIG. 16 is a block diagram illustrating the configuration of the main part of a microcomputer 800 in accordance with a fourth embodiment.

### DESCRIPTION OF THE PREFERRED EMBODIMENTS

Hereinafter, embodiments of the present invention will be described with reference to the accompanying drawings.

(First Embodiment)

(Configuration of Device)

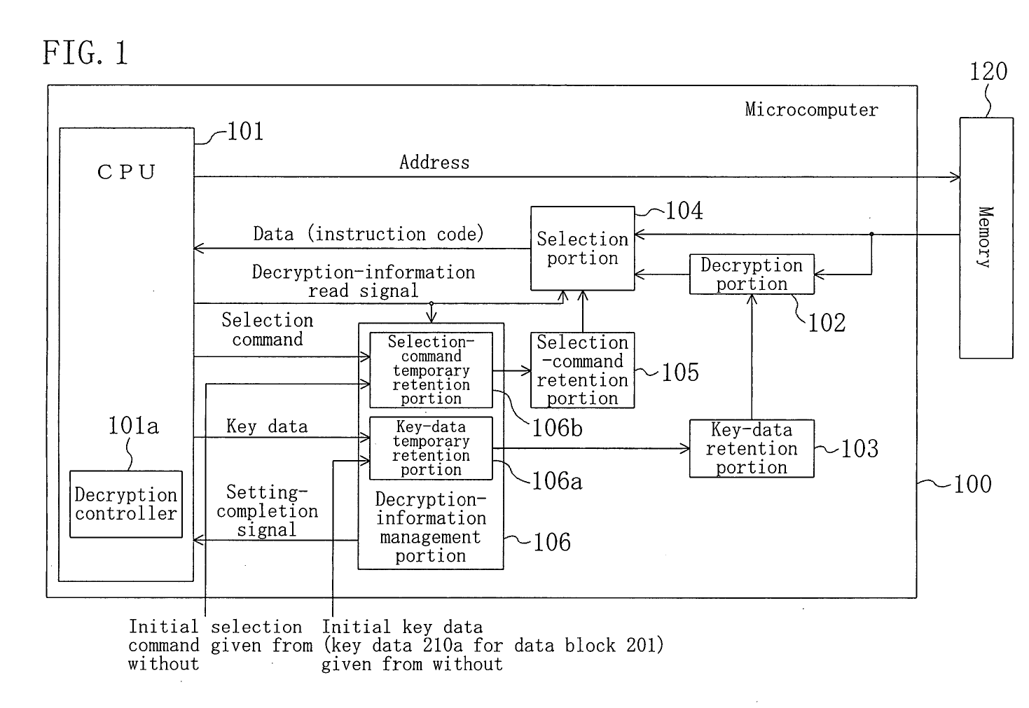

FIG. 1 is a block diagram illustrating the configuration of the main part of a microcomputer 100, which is an exemplary data processing device in accordance with a first embodiment of the present invention, and a memory 120, which serves as a storage medium connected to the microcomputer 100.

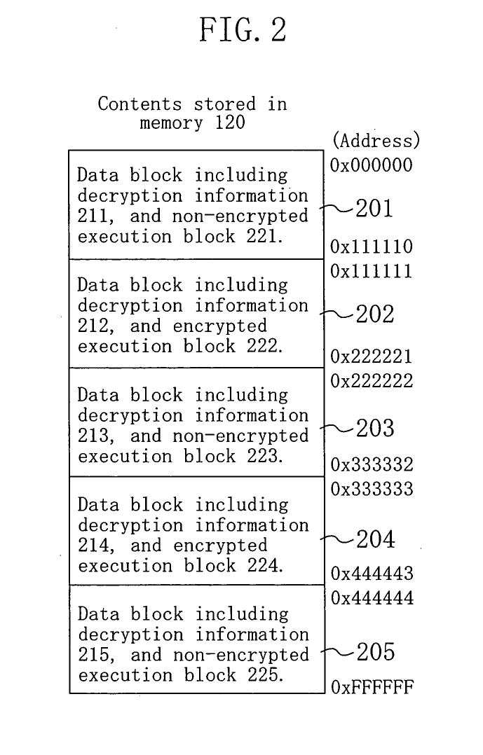

The memory 120, composed of a ROM or a RAM, e.g., stores data that is an encrypted program consisting of instruction codes for instructions that the microcomputer 100 is made to execute. The memory 120 outputs, to a data bus, part of the stored data that corresponds to an address indicated by an address bus. As shown in FIG. 2, for example, in the memory 120, a program (data) composed of a series of instruction codes is stored as five data blocks 201 through 205 in such a manner as will be described in detail later.

Provided in the microcomputer 100 are a CPU 101 (a read controller), a decryption portion 102, a key-data retention portion 103, a selection portion 104, a selection-command retention portion 105, and a decryption-information management portion 106.

The CPU 101, which executes the instruction codes, is provided with a decryption controller 101a. The decryption controller 101a exercises control including the following: when the data blocks 201 through 205 stored in the memory 120 are read, the decryption controller 101a reads decryption information sets 211 through 215 included in the data blocks 201 through 205, and outputs key data sets (decryption keys) and other data to the decryption-information management portion 106.

The decryption portion 102 decrypts encrypted data outputted from the memory 120 using key data set in the key-data retention portion 103.

The selection portion 104 selects, based on a selection command set in the selection-command retention portion 105, either decrypted data outputted from the decryption portion 102, or data (in plain text) directly outputted from the memory 120, and then inputs the selected data into the CPU 101 via an internal bus. However, the selection portion 104, upon receipt of a decryption-information read signal at the H (high) level, e.g., inputted from the CPU 101, selects output from the decryption portion 102, irrespective of the selection command set in the selection-command retention portion 105.

The decryption-information management portion 106 manages key data and a selection command set in the key-data retention portion 103 and the selection-command retention portion 105, respectively. More specifically, the decryption-information management portion 106 temporarily retains, in a key-data temporary retention portion 106a, key data outputted (together with a not-shown output timing signal) from the CPU 101, while setting that retained key data in the key-data retention portion 103 before the decryption information sets 211 through 215 in the data blocks 201 through 205 are read out from the memory 120. The decryption-information management portion 106 also temporarily retains in a selection-command temporary retention portion 106b a selection command outputted (together with a not-shown output timing signal) for the selection portion 104 from the CPU 101, while setting that retained selection command in the selection-command retention portion 105 before execution blocks 221 through 225 included in the data blocks 201 through 205 are read. (Furthermore, upon the completion of the above settings, the decryption-information management portion 106 outputs a setting-completion signal to the CPU 101 to allow the CPU 101 to perform operation such as outputting of a next address. It should be noted that if the above settings are carried out within one clock cycle, for example, it is easy to make the CPU 101 perform the next operation at a suitable point in time, such that the above-mentioned setting-completion signal does not necessarily have to be outputted.) The key-data temporary retention portion 106a and the selection-command temporary retention portion 106b temporarily retain, in addition to the key data and the selection command outputted from the CPU 101 as described above, key data and other data inputted from without with respect to the microcomputer 100 when the first data block is read.

In this embodiment, encryption of the data stored in the memory 120 may be performed by various methods, and is not limited to any particular way. For example, one applicable technique is secret (common) key cryptography such as DES cryptography, in which reversible conversion is possible, that is, a single encryption key is used for both encryption and decryption. Another applicable technique is a method in which with an encryption key being used as an initial value, exclusive OR operation is performed on successively inputted data sets.

It should be noted that the microcomputer 100 is normally provided with, in addition to the above-described elements, other members such as a RAM for keeping temporary data and other data, and an interface used for inputting/outputting data from/into external devices. Moreover, in a case in which the memory 120 functions as a storage medium that is also capable of data writing, the microcomputer 100 further includes a write controller. However, to describe those members is not the principal object of the present invention, so descriptions thereof are omitted herein.

Furthermore, if the microcomputer 100 is composed of a single chip LSI, for example, it becomes harder to analyze signals between the above elements, whereby concealment can be increased, but the present invention is not limited to this.

(Form of Data Stored in the Memory 120)

As shown in FIG. 2, the memory 120 stores the plurality (five in the exemplary case shown in the figure) of data blocks 201 through 205, which include the respective decryption information sets 211 through 215 and the respective execution blocks 221 through 225. These data blocks 201 through 205 are read into the CPU 101 in a predetermined certain order, based on e.g., pointers included in the data blocks 201 through 205. (For the sake of simplicity, this embodiment will be described assuming that the data blocks 201 through 205 are read in that order.)

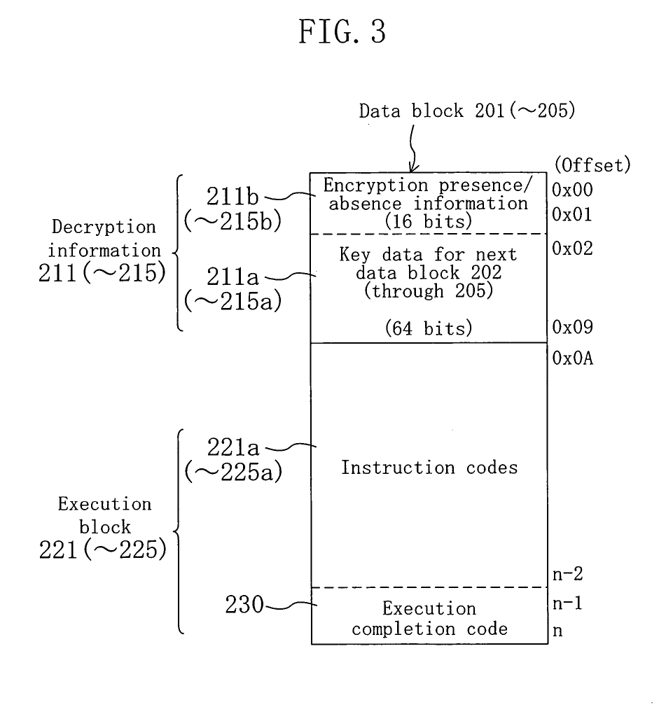

As shown in FIG. 3, for example, the execution blocks 221 through 225 are composed of respective instruction-code groups 221a through 225a and an execution completion code 230 that is added to each instruction-code group. The instruction-code groups 221a through 225a are obtained by dividing a program (data) composed of a series of instruction codes into five execution units. Specific examples of the execution completion code 230 include: a dedicated instruction for causing a branch to a specified branch-destination data block; a combination of an ordinary branch instruction and an instruction for setting a flag that indicates that the branch destination is a different data block; and an ordinary branch instruction that enables the CPU 101 to detect by the address of a branch destination that the branch destination is a different data block. Alternatively, an instruction which indicates, after an ordinary branch instruction has caused a branch to the address of a different data block, that the data block has changed (and which causes a decryption-information read process, for example), may be set at the head of the branched data block or of the execution block in the branched data block. In a case in which a branch-destination data block is specified by an address, the address of the head of the decryption information may be designated as that address, or the address of the head of the execution block, for example, may be designated so as to obtain the address of the head of the decryption information from the data length of the decryption information.

The decryption information sets 211 through 215 include respective key data sets 211a through 215a and respective encryption presence/absence information sets 211b through 215b. (The position of the respective decryption information set 211 through 215 is not limited to the head of the respective data block 201 through 205, but the respective decryption information set 211 through 215 may be located inside or at the bottom of the respective execution block 221 through 225. Furthermore, in a case in which there is no data block next read after the data block 205, that is, when the instructions in the data block 205 are executed repeatedly without making a shift to a different data block, the contents of the key data 215a and of the encryption presence/absence information 215b may be any value, or these data and information may be even omitted.)

The decryption information sets 211 through 215 are all encrypted, while the execution blocks 221 through 225 are encrypted as necessary (for example, the execution blocks 222 and 224 are encrypted.) Key data for decrypting the encrypted data differs by respective data block 201 through 205. The key data sets for decrypting the data blocks 202 through 205 are included in the decryption information sets 211 through 214 in the data blocks 201 through 204, each of which is read immediately before the respective data block 202 through 205 is read. Specifically, for example, the key data 211a included in the decryption information 211 in the data block 201 can decrypt the decryption information 212 and execution block 222 included in the data block 202 that is read next. Key data 210a for decrypting (at least the decryption information 211 in) the data block 201, which is first executed, is not stored in the memory 120, but is given from a device external to the microcomputer 100 at the time of the execution. (In this embodiment, all of the key data sets do not necessarily have to differ from each other. In other words, key data sets selected from among a finite number of key data sets may be used, for example, so that identical key data sets may be used for some of the data blocks.)

The encryption presence/absence information sets 211b through 214b included in the respective decryption information sets 211 through 214 indicate whether the execution blocks 222 through 225 included in the respective next data blocks 202 through 205 are encrypted or not. For example, if the execution block included in the data block that is executed next after each data block is encrypted, the value “0x0010” (where “0x” indicates that the following numerical value is expressed in hexadecimal) is set. On the other hand, if the execution block is not encrypted, the value “0x0001” is set. More specifically, if the execution blocks 222 and 224 in the data blocks 202 and 204 are encrypted as described above, the value “0x0010” is set in the encryption presence/absence information sets 211b and 213b in the data blocks 201 and 203 that are read immediately before the data blocks 202 and 204, respectively, while the value “0x0001” is set in the encryption presence/absence information sets 212b and 214b in the other data blocks 202 and 204.

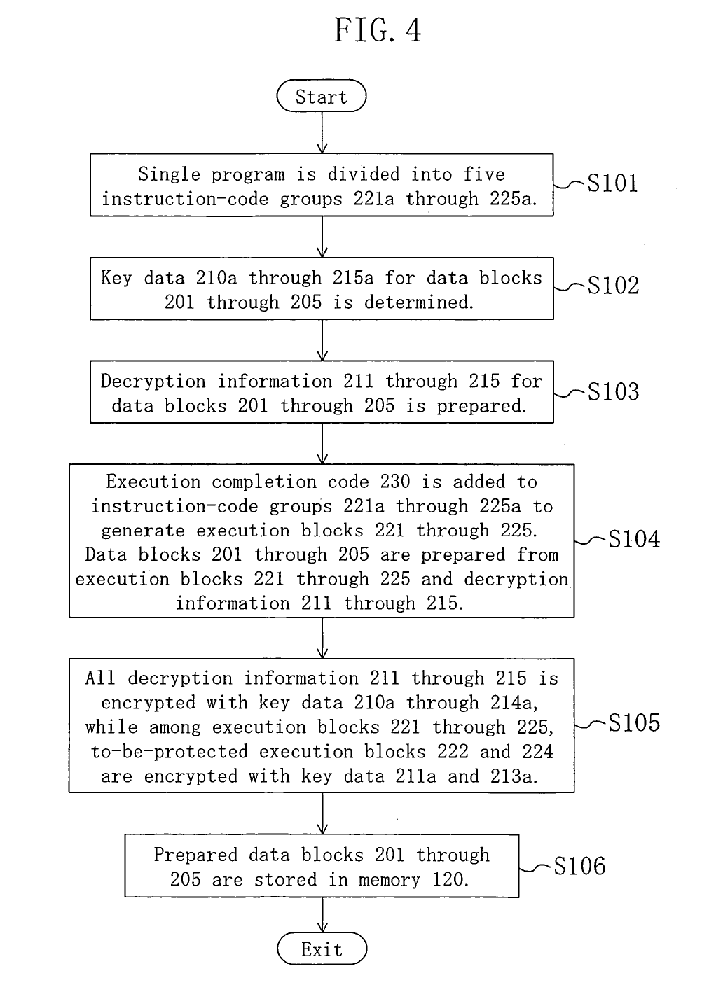

The procedural steps in which the above-described data sets are generated and stored in the memory 120 are not limited to any particular steps, but may be performed as shown in FIG. 4. First, in S101, a program composed of a series of instruction codes is divided into five instruction-code groups 221a through 225a (at a given data length or at a branch instruction located closest to each such given length, for example.) Next, in S102, the key data sets 210a through 215a for encrypting the decryption information sets 211 through 215 and the execution blocks 222 and 224 are set artificially, or automatically by using random numbers. In S103, the key data sets 211a through 215a are then respectively combined with the encryption presence/absence information sets 211b through 215b, thereby generating the decryption information sets 211 through 215. Thereafter, in S104, the execution completion code 230 is added to each of the instruction-code groups 221a through 225a to generate the execution blocks 221 through 225, which are then combined with the respective decryption information sets 211 through 215, thereby forming the data blocks 201 through 205. In S105, all of the decryption information sets 211 through 215 are encrypted using the key data sets 210a through 214a, while the execution blocks 222 and 224 are encrypted with the key data sets 211a and 213a. In S106, the data blocks 201 through 205 are stored in the memory 120.

(Reading and Execution of Data Stored in the Memory 120)

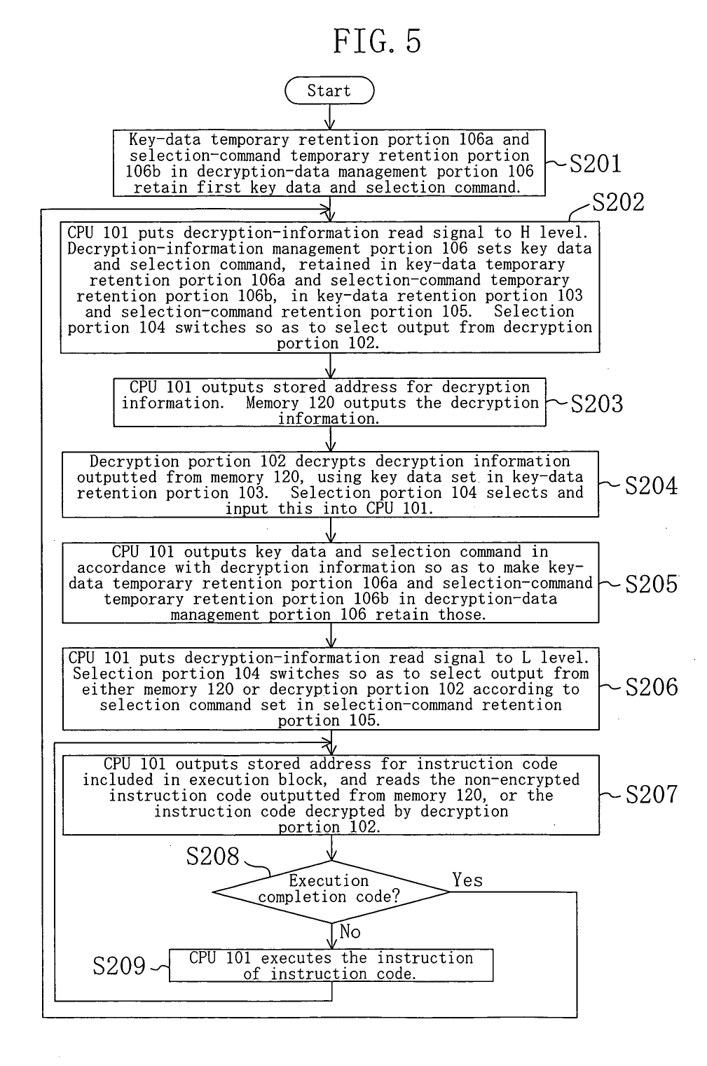

Referring to FIG. 5, it will be described how the program stored in the memory 120 in the above manner is read and executed by the microcomputer 100.

(In S201) When the key data 210a and a selection command (shown in FIG. 1) for the data block 201 that is read first are inputted from without with respect to the microcomputer 100, the key-data temporary retention portion 106a and the selection-command temporary retention portion 106b in the decryption-information management portion 106 retain the key data 210a and the selection command, respectively.

(In S202) Under the control of the decryption controller 101a, the CPU 101 outputs a decryption-information read signal at the H level to the decryption-information management portion 106 and the selection portion 104. In response to this signal, the key data and the selection command, retained in the key-data temporary retention portion 106a and the selection-command temporary retention portion 106b in the decryption-information management portion 106, are set in the key-data retention portion 103 and the selection-command retention portion 105, respectively. The selection portion 104 switches so as to select data outputted from the decryption portion 102 and to output the selected data into the CPU 101, irrespective of the selection command set in the selection-command retention portion 105.

(In S203) Under the control of the decryption controller 101a, the CPU 101 outputs into the memory 120 an address (and a not-shown read control signal) for reading decryption information. In response to this, the memory 120 outputs the decryption information.

(In S204) The decryption portion 102 decrypts the decryption information outputted from the memory 120 based on the key data set in the key-data retention portion 103. The selection portion 104 selects and then inputs into the CPU 101 the output from the decryption portion 102.

(In S205) The decryption controller 101a extracts key data included in the decryption information and outputs the extracted key data into the decryption-information management portion 106 so as to make the key-data temporary retention portion 106a retain that key data temporarily. Further, based on the encryption presence/absence information included in the decryption information, that is, according to whether the execution block in the next data block is encrypted or not, the decryption controller 101a makes the selection-command temporary retention portion 106b in the decryption-information management portion 106 retain a selection command that indicates whether the selection portion 104 will be made to select output from either the decryption portion 102 or the memory 120. (The key data and the selection command will be set in the key-data retention portion 103 and the selection-command retention portion 105, respectively, when the step S202 is executed again to read the next data block.)

(In S206) When the decryption-information read signal outputted from the CPU 101 is put to the L (low) level, the selection portion 104 switches so as to selectively input, into the CPU 101, output from either the decryption portion 102 or the memory 120 based on the selection command set in the selection-command retention portion 105.

(In S207) The CPU 101 outputs an address that correspond to an instruction code included in the execution block, and the instruction code consequently outputted from the memory 120 is inputted via the selection portion 104 into the CPU 101 in a manner in accordance with whether the code is encrypted or not. Specifically, if encrypted, the instruction code is decrypted by the decryption portion 102 before it is inputted into the CPU 101. If not encrypted, on the other hand, the instruction code is inputted into the CPU 101 as it is.

(In S208) If it was the execution completion code 230 that the memory 120 outputted, the process returns to S202 to repeat the same steps for the next data block. (Specifically, the key data and the selection command, temporarily retained in the key-data temporary retention portion 106a and the selection-command temporary retention portion 106b, are set in the key-data retention portion 103 and the selection-command retention portion 105, respectively. Based on these data and command, process steps such as reading of the next data block are performed.)

(In S209) If it was not the execution completion code 230 that the memory 120 outputted, the CPU 101 executes the instruction of the instruction code that has been read, and repeats the steps S207 through S209 until the execution completion code 230 is read.

In the above-mentioned operation, only the single key data set for the data block 201, which is read first, needs to be given to the microcomputer 100 from without. This prevents the management of key data from becoming complicated. Furthermore, even if the single key data set should be leaked, what it can decrypt is only the first data block 201, while each of the key data sets for decrypting the other data blocks is encrypted with one of the other key data sets, preventing all of the data sets stored in the memory 120 from easily being known. Specifically, should the single key data set become known, although obtaining all of the data sets by, based on that single key data set, repeating decryption of the decryption information and extraction of the next key data set would not, theoretically, be impossible, to do so would require various complicated procedures as follows. The encryption algorithm would have to be known, and meanwhile the execution blocks 221 through 225 would have to be analyzed to determine, for example, where the delimiters between the data blocks 201 through 205 are and to determine the data-block read sequence. In addition, the formats of the decryption information sets 211 through 215 and their positions in the data blocks 201 through 205 also would have to be understood (the decryption information sets 211 through 215 are not necessarily located at the heads of the data blocks 201 through 205.) Therefore, it becomes quite difficult to decipher the contents stored in the memory 120. As such difficulty increases, the labor, costs, and time required for the decipherment also increase, thereby practically easily preventing leakage of the stored contents.

As described above, the concealment of the contents stored in the storage medium can be increased. Thus, if such a data processing device is applied to equipment which carries out data-communications by way of a network, for example, programs (algorithms and protocols) for performing, e.g., encryption of sent/received data, and authentication for making sure that the persons at the other end on the network are the right persons, are prevented from being decrypted, whereby the security of the data-communications is easily maintained.

Although in the above-described example, only some of the execution blocks 221 through 225 are encrypted, the present invention is not limited to this, but all of the execution blocks 221 through 225 may be encrypted. In that case, the microcomputer 100 may be designed so as not to be provided with the selection portion 104, the selection-command retention portion 105, and the selection-command temporary retention portion 106b in the decryption-information management portion 106, for example, so that output produced by the memory 120 can always be inputted into the CPU 101 via the decryption portion 102. Furthermore, in that case, the decryption information sets 211 through 215 may be designed without the encryption presence/absence information sets 211b through 215b being provided. This allows the microcomputer 100 to have a more simplified configuration, for example. On the other hand, in a case where only some of the execution blocks are encrypted as in the above-described example, that is, where data, such as programs (routines) for performing standardized processes, that will cause no problem even if it is leaked to a third party, is not encrypted, it is possible to easily reduce the influence of the time required for decoding.

Furthermore, in the case in which only some of the execution blocks are encrypted, key data may be included only in the data blocks (referred to as “encryption data blocks”) that contain those encrypted execution blocks. Specifically, if each encryption data block is designed so as to include key data for decoding the key data and execution block that are contained in the encryption data block next to be read, the other data blocks whose execution block is not encrypted can be designed so as not to include any key data, thereby eliminating the need for decryption operation performed by the decryption portion 102. (It should be noted that in the data blocks in which no key data has to be included, the encryption information may be designed so as to have the same length as the encryption data blocks by setting random numbers therein, for example.)

Moreover, although described in this embodiment is the exemplary case in which each data block includes key data for decoding the key data and execution block that are included in the next data block (or the next encryption data block), each data block may be designed so as to include key data for decoding the execution block included in that data block itself and for decoding the key data included in the next data block (encryption data block). Specifically, until reading of the key data included in each data block is completed, the decoding process may be performed using the key data that is held in the key-data retention portion 103 and that was used to decode the execution block of the previous data block. And at the time of the completion of the decoding process and the start of reading of the execution block, new key data resulting from the decoding process may be set in the key-data retention portion 103 and used. In this case, if the new key data is used immediately after it is decoded, the key-data temporary retention portion 106a and the selection-command temporary retention portion 106b do not necessarily have to be provided.

(Second Embodiment)

The microcomputer of the first embodiment is configured so as to read stored contents in which data blocks are read in a given sequence. In this embodiment, an exemplary microcomputer capable of correctly reading stored contents even if the data bocks are not always read in a certain order due to executed conditional branch instructions, for example, will be described. More specifically, this microcomputer reads and retains key data sets included in each data block which are for all data blocks that have a chance of being read next to that data block, whereby the microcomputer is able to read the data blocks in a flexible sequence. In the following embodiments, members that function in the same manner as those of the first embodiment are identified by the same reference numerals and the description thereof will be omitted herein.

(Configuration of Device)

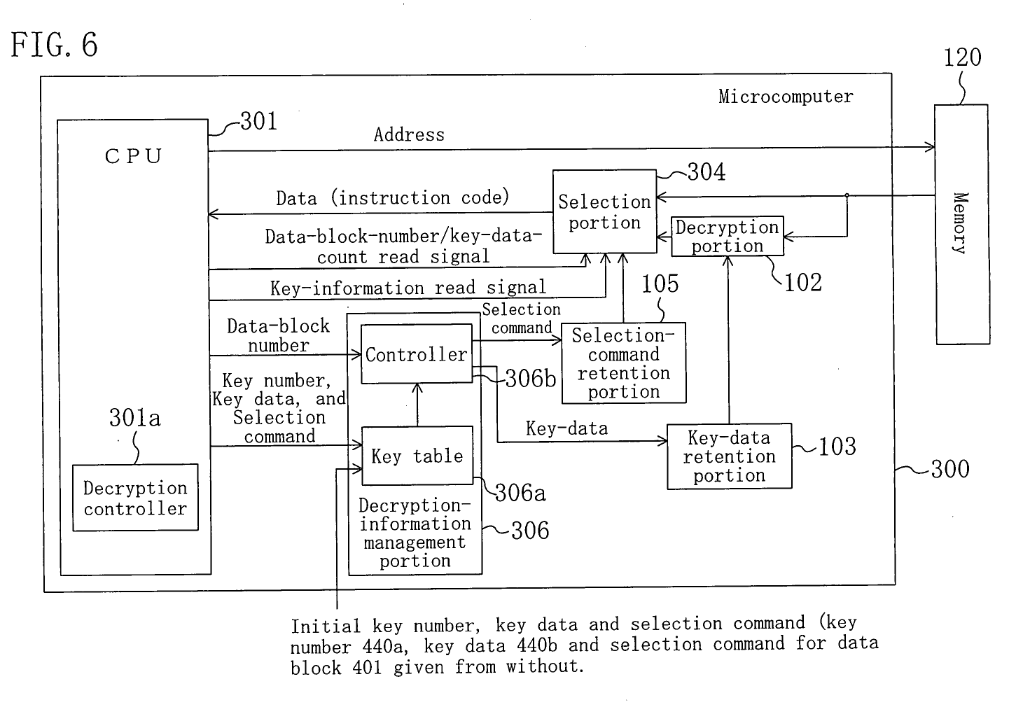

FIG. 6 is a block diagram illustrating the configuration of the main part of a microcomputer 300 in accordance with a second embodiment of the present invention, and a memory 120. The microcomputer 300 is provided with a CPU 301, a selection portion 304, and a decryption-information management portion 306 in place of the CPU 101, the selection portion 104, and the decryption-information management portion 106 included in the microcomputer 100 of the first embodiment (shown in FIG. 1).

The CPU 301 is provided with a decryption controller 301a, which controls reading of decryption information included in data blocks stored in the memory 120. The decryption controller 301a differs from the decryption controller 101a of the first embodiment, because the decryption controller 301a deals with the data blocks which are stored in the memory 120 in a different form from that of the first embodiment, as will be described later.

Like the selection portion 104 of the first embodiment, the selection portion 304 selects output either from the memory 120 or a decryption portion 102 in accordance with a selection command set in a selection-command retention portion 105. However, the selection portion 304 directly selects output from the memory 120 irrespective of the selection command, when a data-block-number/key-data-count read signal inputted from the CPU 301 is put to the H level, for example. On the other hand, the selection portion 304 selects, irrespective of the selection command, output from the decryption portion 102, when a key-information read signal is put to the H level.

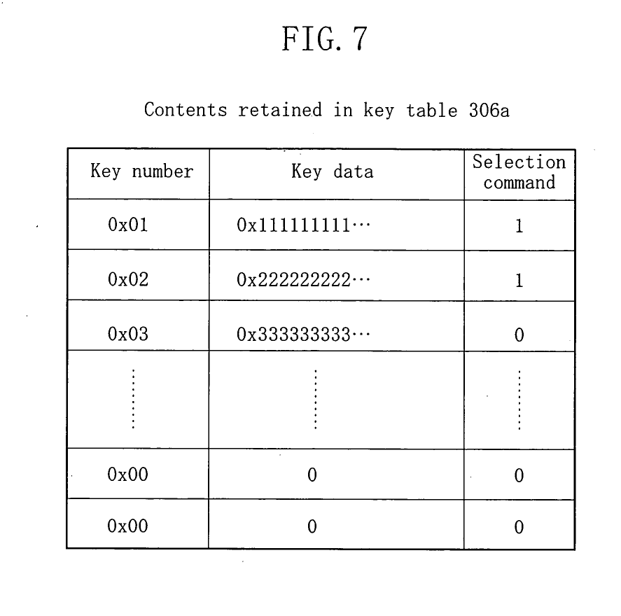

The decryption-information management portion 306 includes a key table 306a and a controller 306b. The key table 306a, upon receipt of a key number, key data and a selection command inputted from the CPU 301, retains them in such a manner that the key data and the selection command are associated with the key number, as shown in FIG. 7, for example. The controller 306b outputs, according to a data block number inputted from the CPU 301, the key data and the selection command associated with the key number that matches to that data block number, included among all of the key data and the selection commands retained in the key table 306a.

(Form of Data Stored in the Memory 120)

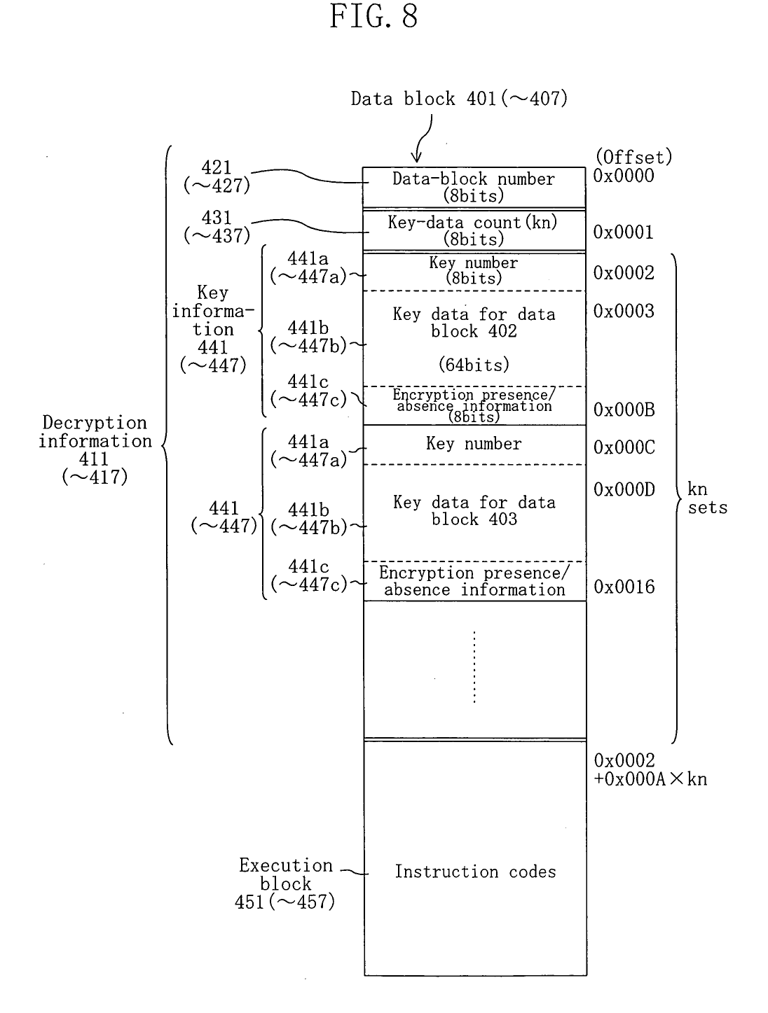

As in the first embodiment, the memory 120 stores a plurality (seven, for example) of data blocks 401 through 407. The data blocks 401 through 407 are configured as shown in FIG. 8, for example. The data block 401 will be mainly discussed more specifically as a representative example. The data block 401 includes an execution block 451 and decryption information 411 that contains a data block number 421, a key data count 431, and one or more key information sets 441. The key information sets 441 through 447 in the data blocks 401 through 407 are all encrypted, while the execution blocks 451 through 457 are encrypted as necessary (only the execution blocks 451 and 452 in the data blocks 401 and 402, for example, are encrypted.)

The data block number 421 in the decryption information 411, which specifies the data block, is set in such a manner as to be uniquely associated with the data block 401.

The key data count 431 indicates the number of key information sets 441 included in the decryption information 411 (that is, the number of data blocks that have a chance of being read next after the data block 401, which will be discussed later.) The key data count 431 is used for the CPU 301 to read all of the key information sets 441 included in the data block 401. Instead of using the key data count 431, a termination code that indicates the end of the decryption information sets 411 may be provided at the end of the decryption information sets 411 so that reading of the key information sets 441 can be finished.

The key information sets 441, which correspond to one or more data blocks that have a possibility of being read by the CPU 301 next after the data block 401, each include a key number 441a, key data 441b, and encryption presence/absence information 441c. More specifically, suppose an exemplary case where a data-block branch instruction, which will be discussed later, causes the execution block 452 of the data block 402 or the execution block 453 of the data block 403 to be selectively executed next after the data block 401, and where the execution block 452 of the data block 402 is encrypted, while the execution block 453 of the data block 403 is not encrypted as described above. In this case, the following two key data information sets 441 are provided in the decryption information 411.

In one of the two key data information sets 441,

(a) a value equal to the data block number 422 of the data block 402 is set as the key number 441a;

(b) key data for decrypting the key information 442 and execution block 452 of the data block 402 is set as the key data 441b; and

(c) a value (e.g., 0x10) that indicates that the execution block 452 is encrypted is set as the encryption presence/absence information 441c.

In the other of the key data information sets 441,

(a) a value equal to the data block number 423 of the data block 403 is set as the key number 441a;

(b) key data for decrypting the key information 443 of the data block 403 is set as the key data 441b; and

(c) a value (e.g., 0x01) that indicates that the execution block 453 is not encrypted is set as the encryption presence/absence information 441c.

It should be noted that instead of providing the key data information sets 441 associated only with the subsequent read-possible data blocks, key data information sets 441 that correspond to all of the data blocks, for example, may be included, so that data-block read sequence does not have to be analyzed when the key information sets 411 are generated, as will be described later.

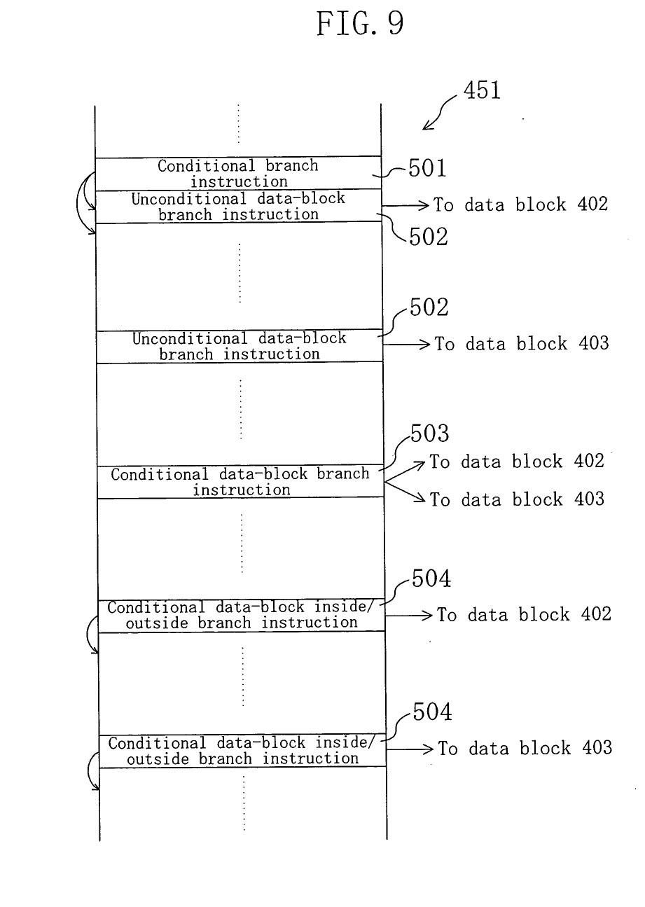

The execution block 451 of the data block 401 is composed of an instruction-code group, which is obtained by dividing a program (data) consisting of a series of instruction codes, and which includes data-block branch instructions for causing branches to other data blocks. More specifically, as shown in FIG. 9, for example, unconditional data-block branch instructions 502 for causing branches to the data blocks 402 and 403 are disposed after a conditional branch instruction 501, whereby the control is shifted to either data block 402 or 403 after a branch is caused in accordance with a condition at the time of the execution of the conditional branch instruction 501. (In other words, since the next data block to shift to is not determined beforehand, shifting to either of the data blocks is possible.) Furthermore, a conditional data-block branch instruction 503 for making a direct shift to the data block 402 or 403 in accordance with the condition, and a conditional data-block inside/outside branch instruction 504 for making a shift to the inside/outside of the data block 401 may be used.

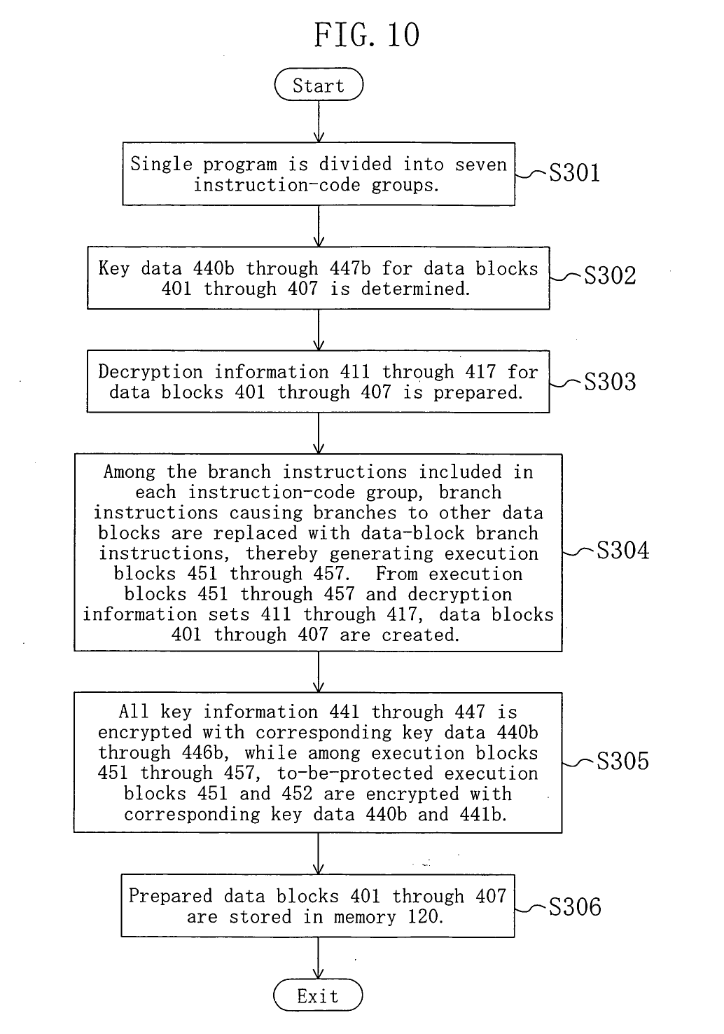

The above-described data sets may be stored in the memory 120 as shown in FIG. 10 as in the first embodiment (see FIG. 4), for example. Specifically, S301, S302, S305, and S306 in FIG. 10 are substantially the same as S101, S102, S105, and S106 shown in FIG. 4. In S303, data block numbers 421 through 427 are assigned to the data blocks 401 through 407, while the instruction-code groups are analyzed to find data blocks that can be branched from the respective data blocks 401 through 407. The key information sets 441 through 447 are then generated from the key numbers 441a through 447a, the key data sets 441b through 447b, and the encryption presence/absence information 441c through 447c that correspond to the branch-destination data blocks. The decryption information sets 411 through 417 are created by connecting the assigned data block numbers 421 through 427, the key data counts 431 through 437 each equal to the number of branch destinations, and the key information sets 441 through 447. In S304, among the branch instructions included in each instruction-code group, branch instructions causing branches to other data blocks are replaced with data-block branch instructions, thereby generating the execution blocks 451 through 457. From the execution blocks 451 through 457 and the decryption information sets 411 through 417, the data blocks 401 through 407 are created. It should be noted that instead of performing the above-mentioned branch-instruction replacement, data-block branch instructions may be included in the original program when the original program is generated.

(Reading and Execution of Data Stored in the Memory 120)

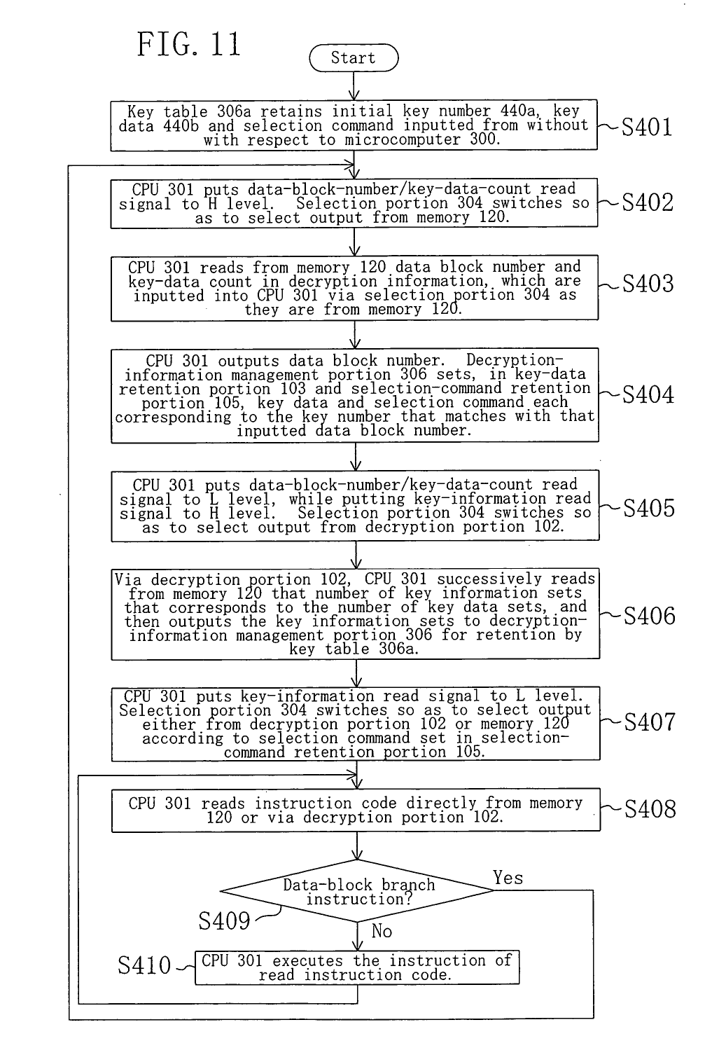

Referring to FIG. 11, it will be described how the program stored in the memory 120 in the above manner is read and executed by the microcomputer 300.

(In S401) Inputted from without with respect to the microcomputer 300 are the key data 440b for a data block that is read first, for example, for the data block 401, the key number 440a that indicates that the key data 440b corresponds to the data block 401 (that is, the value equal to the data block number 421 of the data block 401), and a selection command that indicates that the selection portion 304 will select output from the decryption portion 102 when the encrypted execution block 451 is read. The key table 306a in the decryption-information management portion 306 retains these data and command.

(In S402) Under the control of the decryption controller 301a, the CPU 301 outputs a data-block-number/key-data-count read signal at the H level, for example, to the selection portion 304. In response to this signal, the selection portion 304 switches so as to directly select output from the memory 120, irrespective of a selection command outputted from the selection-command retention portion 105.

(In S403) Under the control of the decryption controller 301a, the CPU 301 successively outputs to the memory 120 addresses (and a not-shown read-control signal) for reading the data block number and the key data count in the decryption information set. In response to this, the memory 120 outputs the data block number and the key data count. The data block number and the key data count are inputted into the CPU 301 via the selection portion 304 as they are (without being decrypted by the decryption portion 102).

(In S404) The CPU 301 outputs the data block number (together with a not-shown output timing signal) to the decryption-information management portion 306. Then, the controller 306b outputs, to the key-data retention portion 103 and the selection-command retention portion 105, the key data and the selection command each corresponding to the key number that matches with that inputted data block number included among all the key numbers retained in the key table 306a, so that the key data and the selection command are set in the key-data retention portion 103 and the selection-command retention portion 105, respectively. In this step, in determining which one of the key numbers retained in the key table 306a matches with the data block number, all the key numbers retained may be checked simultaneously by parallel processing, or comparisons may be made successively until the match is found. However, particularly in the latter case, if the time required for the detection is inconstant, it is preferable that a detection signal that indicates that the match has been found, or a setting-completion signal that indicates that the settings in the key-data retention portion 103 and the selection-command retention portion 105 have been completed, be outputted to the CPU 301. Meantime, it is preferable for the CPU 301 not to commence key-information 411 read operation (such as output of an address), until such signal is inputted.

(In S405) The CPU 301 puts the data-block-number/key-data-count read signal to the L level, while putting the key-information read signal to the H level, such that the selection portion 304 switches so as to select output from the decryption portion 102.

(In 406) Via the selection portion 304, the CPU 301 successively reads from the memory 120 that number of key information sets that corresponds to the key data count, and then outputs the key numbers, the key data sets, and selection commands according to the encryption presence/absence information sets (together with a not-shown output timing signal) to the decryption-information management portion 306 so as to make the key table 306a retain those.

(In S407) Upon the completion of the process regarding the number of key information sets that corresponds to the key data count, the CPU 301 puts the key-information read signal to the L level. Then, the selection portion 304 switches so as to selectively input, to the CPU 301, output either from the decryption portion 102 or the memory 120 according to the selection command set in the selection-command retention portion 105.

(In S408) The CPU 301 outputs an address corresponding to an instruction code in the execution block, and the memory 120 outputs the instruction code. The instruction code is then inputted via the selection portion 304 into the CPU 301 in a manner in accordance with whether the code is encrypted or not. Specifically, if encrypted, the instruction code is decrypted by the decryption portion 102 before it is inputted into the CPU 301. On the other hand, if not encrypted, the instruction code is inputted into the CPU 301 as it is.

(In S409) If the instruction of the instruction code inputted into the CPU 301 was a data-block branch instruction, the process returns to S402 to repeat the same steps for the next data block.

(In S410) If the instruction was not a data-block branch instruction, the CPU 301 executes the instruction of the read instruction code, and repeats S408 through S410 until a data-block branch instruction code is read.

As described above, each data block is designed so as to include one or more key data sets corresponding to (a) branch-destination data block(s). This allows the contents of the data blocks to be correctly read, even if the data blocks are not read in a given sequence. Accordingly, concealment of the stored contents can be increased as in the first embodiment, and in addition, it becomes easy to prepare and divide programs in a flexible manner.

It should be noted that, instead of designing the data blocks that include (encrypted) key data for data blocks that can be branch destinations, the data blocks may be configured as follows: each data block that becomes a branch destination may include a plurality of identical key data sets for that data block, which key data sets may be encrypted in the same manner as data blocks that can be branch origins that branch to that data block. More specifically, among the plurality of encrypted key data sets read in each branch-destination data block, one key data set corresponding to the branch-origin data block may be decrypted using the same key data set as that for the branch-origin data block. The appropriate key data for that data block can thus be obtained.

(Third Embodiment)

Another exemplary microcomputer capable of reading data blocks in any arbitrary sequence will be discussed below as in the second embodiment.

(Format of Data Stored in the Memory 120)

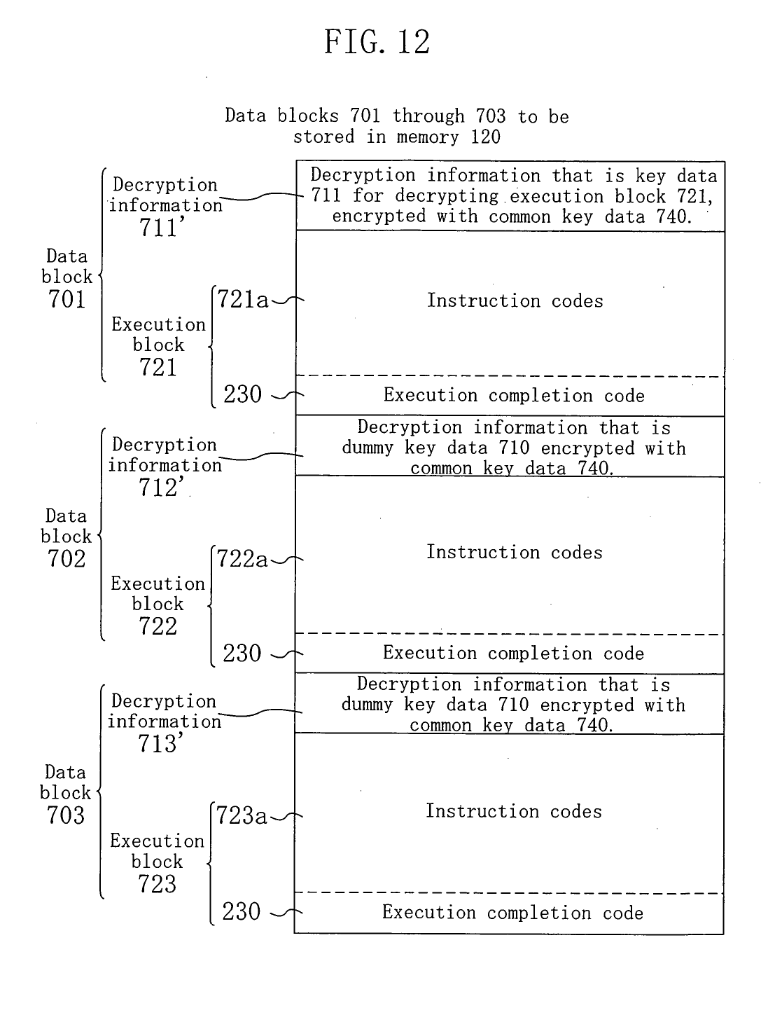

First, referring to FIG. 12, in what form data that the microcomputer reads is stored in the memory 120 will be described. In the memory 120, a plurality (three, for example) of data blocks 701 through 703 are stored. The data blocks 701 through 703 are composed of decryption information 711′ through 713′ and execution blocks 721 through 723. As in the first embodiment, the execution blocks 721 through 723 include instruction-code groups 721a through 723a, obtained by dividing a program (data) composed of a series of instruction codes into three execution units, and an execution completion code 230 added to the respective instruction-code groups 721a through 723a. The execution blocks 721 through 723 are encrypted as necessary (for example, the execution block 721 is encrypted.)

The decryption information 711′ of the data block 701 that includes the encrypted execution block 721 is key data 711 for decrypting the execution block 721, encrypted with a given common key data 740. On the other hand, the decryption information sets 712′ and 713′ of the data blocks 702 and 703 that include the non-encrypted execution blocks 722 and 723 are given dummy key data sets 710 encrypted with the common key data 740 that is commonly used by the data block 701. (Unlike in the first and second embodiments, the decryption information sets 711 through 713′ do not include any encryption presence/absence information, which will be discussed later.) The common key data 740 is not limited to any particular data. Nevertheless, if the common key data 740 differs by each system, data concealment can be increased easily. Furthermore, the encryption of the key data 711 with the common key data 740 as well as the encryption of the execution block 721 may be done by various methods such as secret key cryptography.

(Configuration of Device)

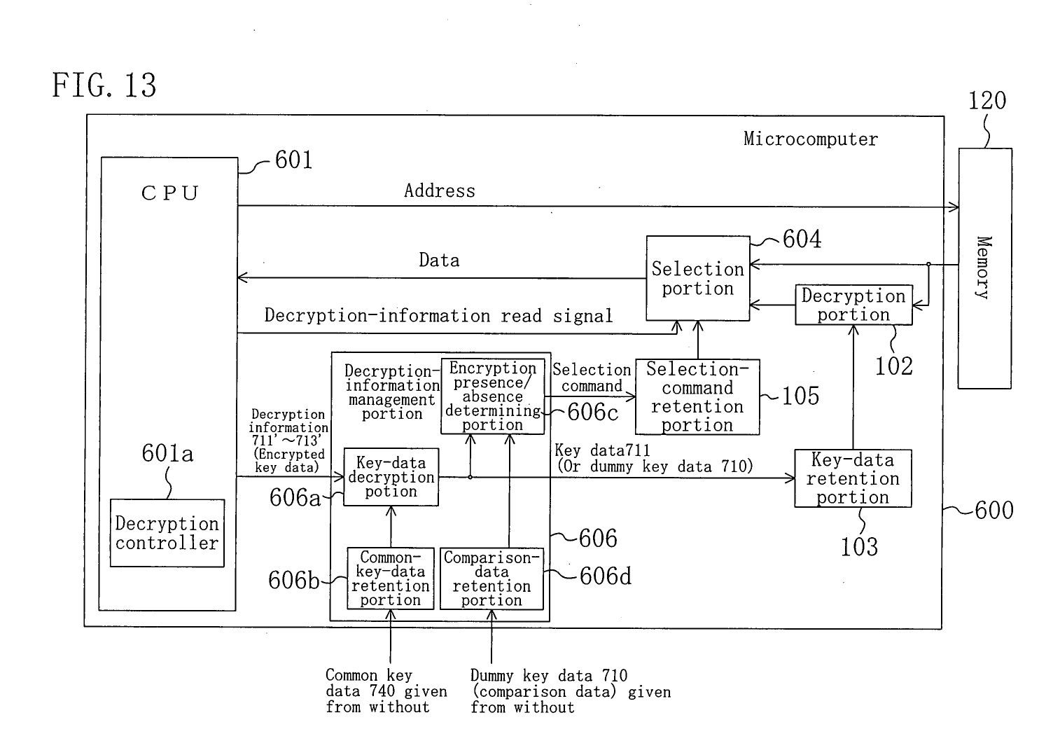

As shown in FIG. 13, the microcomputer 600 that reads the above-mentioned stored contents is provided with a CPU 601, a selection portion 604, and a decryption-information management portion 606 in place of the CPU 101, the selection portion 104, and the decryption-information management portion 106 included in the microcomputer 100 of the first embodiment (shown in FIG. 1).

The decryption controller 601a provided in the CPU 601 differs from the decryption controller 101a of the first embodiment, because as described above, the form of the data blocks stored in the memory 120 is different form that of the first embodiment.

The selection portion 604 selects output from the memory 120 irrespective of a selection command set in a selection-command retention portion 105, when a decryption-information read signal at the H level, for example, is inputted.

The decryption-information management portion 606 includes a key-data decryption potion 606a (a second decryption portion), a common-key-data retention portion 606b (a second key-data retention portion), an encryption presence/absence determining portion 606c, and a comparison-data retention portion 606d.

The key-data decryption potion 606a decrypts the decryption information 711′ through 713′ (the encrypted key data 711 or the encrypted dummy key data 710) that the CPU 601 read from the memory 120 and inputted, and outputs the original key data 711 or the original dummy key data 710. In decrypting the key data, the common key data 740, inputted from without with respect to the microcomputer 600 and retained in the common-key-data retention portion 606b, is used.

The encryption presence/absence determining portion 606c compares the output from the key-data decryption potion 606a with the dummy key data 710 that is inputted from without with respect to the microcomputer 600 and retained in the comparison-data retaining portion 606d. If the output and the dummy key data 710 match with each other, the encryption presence/absence determining portion 606c outputs a selection command for making the selection portion 604 select output from the memory 120. If they do not match with each other, on the other hand, the encryption presence/absence determining portion 606c outputs a selection command for making the selection portion 604 select output from a decryption portion 102 (a first decryption portion). Specifically, when the key-data decryption potion 606a decrypts the decryption information sets 712′ and 713′ of the data blocks 702 and 703 whose execution blocks 722 and 723 are not encrypted, the key-data decryption potion 606a outputs the dummy key data 710. Then, since the encryption presence/absence determining portion 606c determines that this dummy key data 710 matches with the dummy key data 710 retained in the comparison-data retention portion 606d, it can be decided that the execution blocks 722 and 723 are not encrypted, such that the selection portion 604 can be made to select output from the memory 120. (In this case, even if a key-data retention portion 103 (a first key-data retention portion) retains the dummy key data 710, the selection portion 604 does not select output from the decryption portion 102, such that data inputted into the CPU 601 is not affected.)

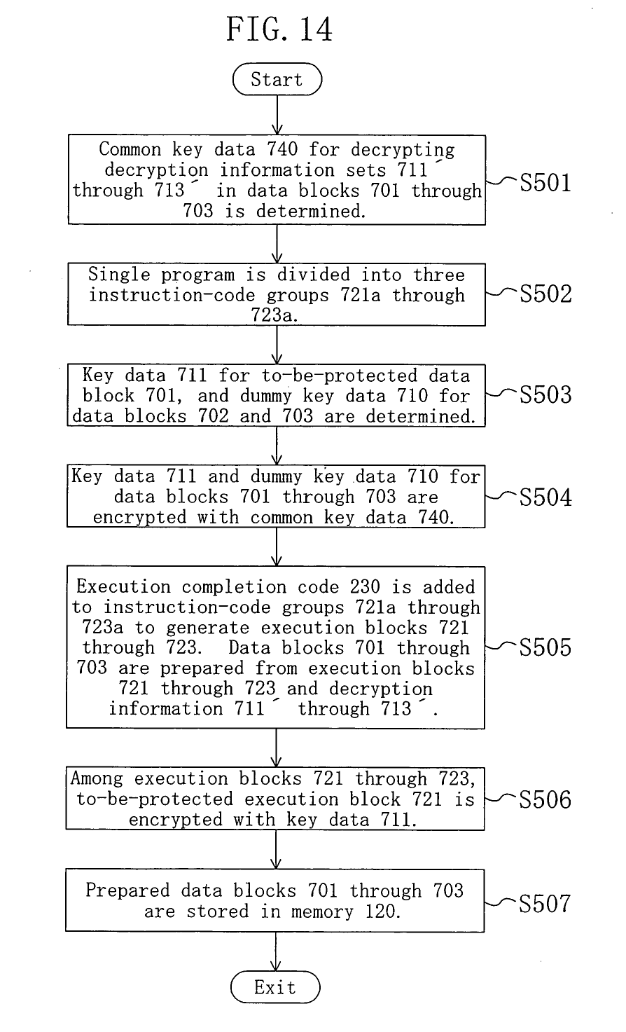

The above-mentioned data can be stored in the memory 120 as shown in FIG. 14, for example. In FIG. 14, S502, S505, and S507 are substantially the same as S101, S104, and S106 in the first embodiment (shown in FIG. 4). In S501, the common key data 740, which is used to decrypt the decryption information sets 711′ through 713′ of the data blocks 701 through 703 so as to obtain the key data 711 and the dummy key data 710, is determined. In S503, the key data 711 for the data block 701 is determined, and the dummy key data 710 for the data blocks 702 and 703 is also determined. In S504, the key data 711 and the dummy key data 710 are encrypted with the common key data 740 to obtain the decryption information 711′ through 713′. In S506, only the execution block 721 is encrypted with the key data 711.

(Reading and Execution of Data Stored in the Memory 120)

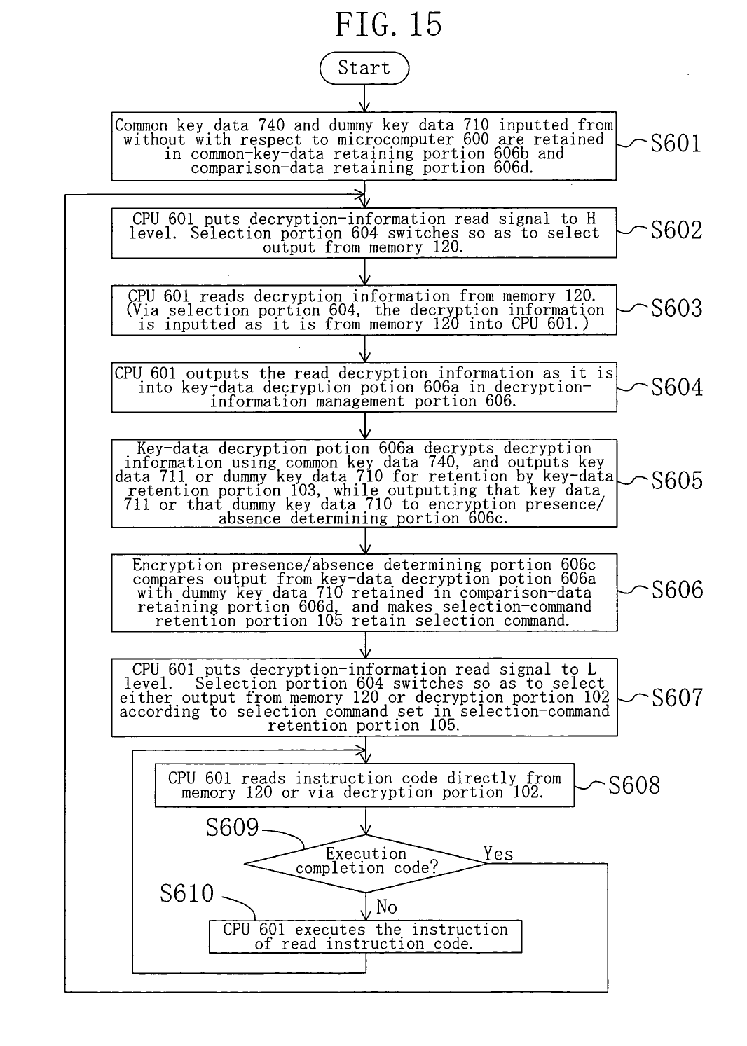

Referring to FIG. 15, it will be described how the program stored in the memory 120 in the above manner is read and executed by the microcomputer 600.

(In S601) The common key data 740 and the dummy key data 710 are inputted from without with respect to the microcomputer 600. The common-key-data retaining portion 606b and the comparison-data retaining portion 606d in the decryption-information management portion 606 retain the inputted data sets.

(In S602) Under the control of the decryption controller 601a, the CPU 601 outputs a decryption-information read signal at the H level, for example, to the selection portion 604. In response to this signal, the selection portion 604 switches so as to directly select output from the memory 120 irrespective of a selection command outputted from the selection-command retention portion 105.

(In S603) Under the control of the decryption controller 601a, the CPU 601 outputs to the memory 120 an address for reading decryption information (and a not-shown read-control signal). In response to this, the memory 120 outputs the decryption information. Via the selection portion 604, the decryption information is inputted into the CPU 601 as it is (without being decrypted by the decryption portion 102). In this step, the decryption information is not decrypted by the decryption portion 102, because it will be decrypted by the key-data decryption potion 606a.

(In S604) The CPU 601 outputs the inputted decryption information (together with a not-shown output timing signal) into the key-data decryption potion 606a in the decryption-information management portion 606.

(In S605) The key-data decryption potion 606a decrypts the decryption information inputted from the CPU 601 by using the common key data 740 retained in the common-key-data retaining portion 606b. The key-data decryption potion 606a then sets the obtained key data 711 (or the dummy key data 710) in the key-data retention portion 103, while outputting that key data 711 (or the dummy key data 710) to the encryption presence/absence determining portion 606c.

(In S606) The encryption presence/absence determining portion 606c compares the output from the key-data decryption potion 606a with the dummy key data 710 retained in the comparison-data retaining portion 606d. If the output and the dummy key data 710 matches with each other, the encryption presence/absence determining portion 606c outputs a selection command that makes the selection portion 604 select output from the memory 120. If the output and the dummy key data 710 do not match with each other, on the other hand, the encryption presence/absence determining portion 606c outputs a selection command that makes the selection portion 604 select output from the decryption portion 102. In both cases, the outputted selection command is set in the selection-command retention portion 105. Specifically, if it was the dummy key data 710 that the key-data decryption potion 606a decrypted, which means that the execution block of that data block is not encrypted, the encryption presence/absence determining portion 606c makes the selection portion 604 select output from the memory 120, so that the output is inputted as it is into the CPU 601. On the other hand, if it was not the dummy key data 710 that the key-data decryption potion 606a decrypted, which means that what the key-data decryption potion 606a decrypted was the key data, the encryption presence/absence determining portion 606c makes the selection portion 604 select output from the decryption portion 102, and input into the CPU 601 the data decrypted using the key data 711 set in the key-data retention portion 103 in S605.

(In S607) When the decryption-information read signal outputted from the CPU 601 becomes at the L level, the selection portion 604 switches so as to selectively input into the CPU 601 either output from the decryption portion 102 or the memory 120 according to a selection command set in the selection-command retention portion 105.

(In S608) The CPU 601 outputs an address corresponding to an instruction code in the execution block, and the instruction code consequently outputted from the memory 120 is inputted via the selection portion 604 into the CPU 601 in a manner in accordance with whether the code is encrypted or not. Specifically, if encrypted, the instruction code is decrypted by the decryption portion 102 before it is inputted into the CPU 601. If not encrypted, the instruction code is inputted into the CPU 601 as it is.

(In S609) If the output from the memory 120 was the execution completion code 230, the process returns to S602 to repeat the same steps for the next data block.

(In S610) If it was not the execution completion code 230 that the memory 120 outputted, the CPU 601 executes the instruction of the read instruction code and repeats S608 through S610 until the execution completion code 230 is read.

As described above, key data for decrypting each execution block is included in the data block in which that execution block is included. This permits the key data to be obtained independently of the data-block read sequence, allowing the data blocks to be read in a desired manner. Furthermore, only the above-mentioned common key data (for decrypting the key data used to decode the execution blocks) has to be given from (managed by) without with respect to the microcomputer 600, which also enables simplification of key-data management. Should the common key data be leaked, decryption of a plurality of key data sets would be possible. However, the leaked common key data would be able to decode only the key data sets, and in order to obtain the stored data, further decryption using those key data sets would be required. To carry out such further decryption, in addition to those key data sets, the encryption algorithm would have to be known, and meanwhile it would have to be known where the delimiters between the data blocks 701 through 703 and between the decryption information sets 711′ through 713′ and the execution block 721 through 723 are, and where the decryption information sets 711′ through 713′ are located, for example. Those complicated procedures make decryption of the contents stored in the memory 120 still quite difficult, thereby practically easily preventing the stored contents from being leaked.

In the above-described exemplary case, the encryption presence/absence determining portion 606c compares output from the key-data decryption potion 606a with output from the comparison-data retaining portion 606d. However, output from the key-data retention portion 103 and the output from the comparison-data retaining portion 606d may be compared with each other. In that case, the selection-command retention portion 105 does not have to be provided, because during the period in which the value that the key-data retention portion 103 retains remains the same, output from the encryption presence/absence determining portion 606c is also kept unchanged.

Alternatively, the decryption information 711′ through 713′ (which has not been decrypted by the key-data decryption potion 606a) outputted from the CPU 601 may be compared with the output from the comparison-data retaining portion 606d. In this case, the dummy key data 710 does not have to be encrypted when the decryption information 712′ and 713′ of the data blocks 702 and 703 are generated.

Furthermore, in the above-described exemplary case, the key-data decryption potion 606a decrypts the decryption information 711′ through 713′, while the decryption portion 102 decrypts the execution blocks 721 through 723. However, the present invention is not limited to this. For instance, to decrypt the decryption information 711′ through 713′ and the execution blocks 721 through 723, the common key data 740 or the key data 711 may be set in the key-data retention portion 103, so that the decryption portion 102 can decrypt both. Such sharing of the decryption portion permits the hardware to decrease in size. On the other hand, as described above, in a case in which separate decryption portions are provided, their decryption processes can easily employ different algorithms, as compared to the case where the decryption portion is shared. Particularly, in key-data decryption, which is performed only one time for each data block, an encryption technique whose encryption strength is high can be easily adopted without causing any serious influence on the processing time of the microcomputer 600.

Moreover, suppose, for example, a case where the key-data decryption potion 606a requires a plurality of clock cycles to perform its decryption process, or the required clock cycle is variable, because of loop operation and for some other reason. In such a case, the decryption-information management portion 606 may be made to output a setting-completion signal at the time that the key-data decryption potion 606a has completed its decryption process and has set the resultant key data in the key-data retention portion 103. And, until such a setting-completion signal is inputted into the CPU 601, the CPU 601 may be made to stop its data-read operation such as output of the next address. Then, it is easy to reliably input data decrypted by the decryption portion 102 into the CPU 601.

(Fourth Embodiment)

As explained above, in one of the modified examples of the third embodiment, the operation of the CPU 601 may be kept halted in the interval after the CPU 601 has outputted to the key-data decryption potion 606a the decryption information 711′ through 713′ read from the memory 120 and until the key-data decryption potion 606a completes the decryption process and set the resultant key data 711 in the key-data retention portion 103. In this case, if signals sent/received between the microcomputer 600 and the memory 120 have been monitored, deducing that the microcomputer 600 has operated in a different manner from that when the microcomputer 600 performs ordinary memory access is made easier. If someone trying to fraudulently obtain the contents stored in the memory 120 were to suppose that the decryption process is performed inside the CPU 601 during the period in which no address is outputted, that person would tend to focus his or her attention on the region with the address that has been outputted immediately before that period. Even in that case, the region focused on does not necessarily store key data. Furthermore, as described above, unless the encryption algorithm and other data are known, deciphering the contents stored in the memory 120 remains difficult. Nevertheless, in order to make unlikely the occurrence of a specific region being focused on as mentioned above, dummy addresses may be outputted from the microcomputer 600.

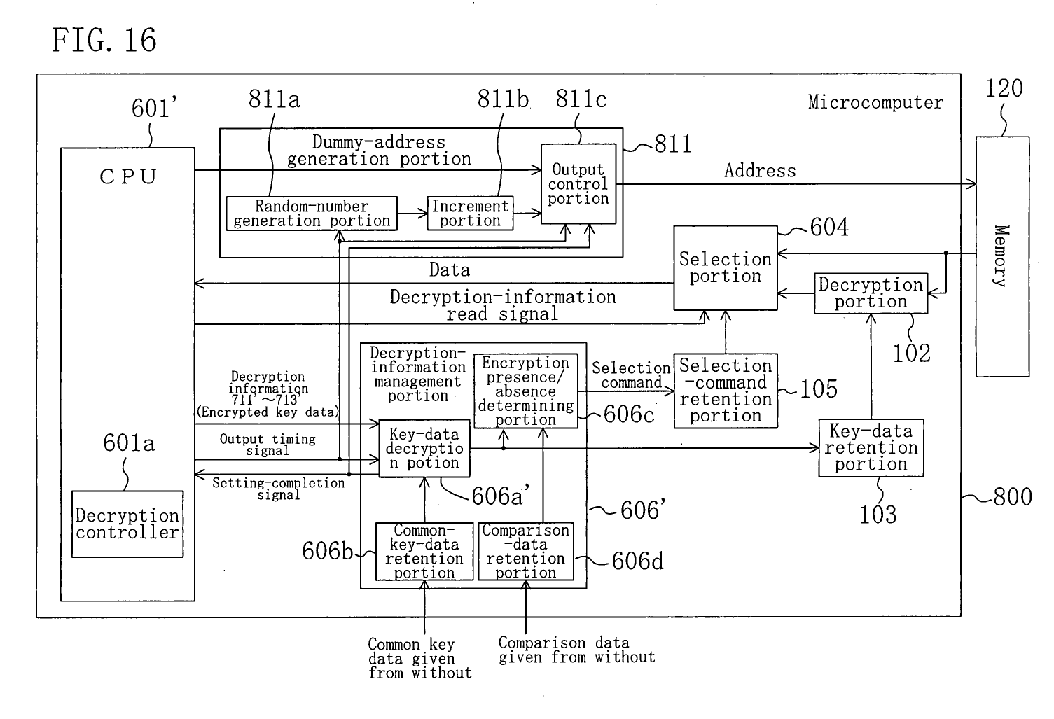

More specifically, a microcomputer 800 shown in FIG. 16, for example, includes a dummy-address generation portion 811 (a dummy read-signal output portion) in addition to a CPU 601 and a decryption-information management portion 606′ including a key-data decryption potion 606a′, provided in place of the CPU 601 and the decryption-information management portion 606 included in the microcomputer 600 of the third embodiment (shown in FIG. 13).

The key-data decryption portion 606a′ outputs a setting-completion signal at the H level, for example, into the CPU 601′ at the time that the key-data decryption portion 606a′ has completed decryption process and set the resultant key data in the key-data retention portion 103.

The CPU 601′, which operates basically in the same manner as the CPU 601, keeps its data-read operation, such as outputting of the next address, halted during the period in which the key-data decryption potion 606a′ in the decryption-information management portion 606′ performs the decryption process of the encrypted key data (that is, in the interval after the CPU 601′ has outputted to the key-data decryption potion 606a′ an output-timing signal at the H level, for example, together with the decryption information 711′ through 713′ and until the key-data decryption potion 606a′ inputs the setting-completion signal at the H level, for example, to the CPU 601′.)

The dummy-address generation portion 811 outputs dummy addresses in the interval after the output-timing signal for the decryption information 711′ through 713′, outputted from the CPU 601′, has been put to the H level and until the setting-completion signal outputted from the key-data decryption potion 606a′ is put to the H level. More specifically, at the time that the output-timing signal outputted from the CPU 601′ becomes at the H level, a random-number generation portion 811a generates a random number, and the random number is set (retained) as an initial value in an increment portion 811b. The increment portion 811b successively increments the retaining value in accordance with a not-shown clock signal, and outputs the incremented value as a dummy address. An output control portion 811c outputs the value outputted from the increment portion 811b (and a not-shown read control signal) during the interval after the output timing signal goes to the H level and until the setting-completion signal goes to the H level. Other than that, however, the output control portion 811c outputs addresses outputted from the CPU 601′ as they are. (If dummy addresses are outputted as described above, the memory 120 outputs invalid data. However, during such a period, the CPU 601′ keeps its data-read operation halted as mentioned above, so that the outputted invalid data is not taken into the CPU 601.)

It should be appreciated that although the foregoing embodiments describe exemplary cases in which the memory 120 stores programs, the present invention is not limited to this. The present invention is applicable to cases in which mere data, which is read by execution of a given program (a read program), for example, is divided, encrypted and stored in a similar manner. In that case, the sequence of reading the data blocks may be determined beforehand by the read program, or may be controlled by pointers or management information included in the data blocks. In other words, the effects of the present invention can be obtained in either case, if it is determined which data block will be read following which data block, and key data is included in the data blocks in accordance with the data-block read sequence thus determined. In a case in which mere data is encrypted and stored as mentioned above, if a read program for reading the stored data is also encrypted, concealment can be increased to a higher degree. Nevertheless, even if the read program is not encrypted, decryption of the content itself that the read program reads can still be made quite difficult.

Moreover, in the above exemplary cases, although the initial value for data such as key data set in the key-data retention portion 103 is inputted from without with respect to the microcomputer 100, the present invention is not limited to this. A value set beforehand in the microcomputer 100 may be used as the initial value.

Furthermore, the data configuration shown in FIG. 3 and other figures are illustrated theoretically, so the physical storage area in the memory 120 does not necessarily have to have the relationship shown in FIG. 3 and other figures.

Also, the elements and configurations described in the foregoing embodiments and modified examples may be combined with each other in various ways, so long as the resultant combination is theoretically possible. For instance, in the second through fourth embodiments, the microcomputers may be designed so as not to be provided with the selection portion, and so as to read data blocks in which all execution blocks are encrypted, as explained in the modified example of the first embodiment. In the first and second embodiments, instead of using the encryption presence/absence information for the switching of the selection portion, dummy key data may be used as explained in the third and fourth embodiments. On the other hand, in the third and fourth embodiments, the switching may be done according to encryption presence/absence information. Furthermore, in the first and second embodiments, key data included in each decryption information may be decrypted by common key data, as in the third and fourth embodiments.

As described above, in the present invention, data to be stored in a storage medium is divided into a plurality of units, and the plurality of data units are encrypted for decryption by different key data sets. Each of those key data sets is also encrypted for decryption by any one of the other key data sets. The encrypted data units and the encrypted key data sets are then stored in the storage medium. The stored contents are read in such a manner that key data decrypted from one encrypted key data set is used for decryption of one encrypted data unit and the next key data, and then the next key data is used for the subsequent decryption process. In this manner, it is possible to make it more difficult for a third person to illegitimately obtain the content stored in the storage medium, while eliminating the need for managing a plurality of key data sets. As a result, it is possible to prevent the data stored in the storage medium from easily being leaked to a third person, without causing the encryption key management to be complex.

What is claimed is:

1. A data processing device which reads and decrypts encrypted data sets and encrypted key data sets stored in a storage medium, the encrypted data sets being obtained by dividing to-be-stored data into a plurality of divided data sets and then encrypting at least some of the divided data sets for decryption by respectively different key data sets, each of the encrypted key data sets being obtained by encrypting each said key data set for decryption by any one of the other key data sets, the data processing device comprising:
a read-control portion for controlling reading of each said encrypted data set and each said encrypted key data set;
a decryption portion for decrypting the encrypted data set and the encrypted key data set that have been read under the control of the read-control portion; and
a key-data retention portion that retains one of the key data sets that has been decrypted from the encrypted key data set by the decryption portion,
wherein the decryption portion is configured so as to decrypt the encrypted data set and the encrypted key data set based on one of the key data sets that has been already retained in the key-data retention portion.

2. The data processing device of claim 1, wherein
the read-control portion is configured so as to successively read, in a uniquely determined order, the encrypted data sets and the encrypted key data sets stored in the storage medium, the encrypted data sets being obtained by encrypting all of the divided data sets, the encrypted key data sets being obtained by encrypting the key data sets for decrypting the respective encrypted data sets; and
the decryption portion is configured
so as to decrypt, based on one of the key data sets that is retained in the key-data retention portion, a first one of the encrypted data sets and a first one of the encrypted key data sets read from the storage medium, and then output a first one of the divided data sets and a first one of the key data sets, and
so as to decrypt, based on the first key data set decrypted and retained in the key-data retention portion, a second one of the encrypted data sets and a second one of the encrypted key data sets read following on the first encrypted data set and the first encrypted key data set.

3. The data processing device of claim 1, wherein
the read-control portion is configured so as to successively read, in a uniquely determined order,
the encrypted data sets that are said encrypted ones of the plurality of divided data sets stored in the storage medium,
non-encrypted data sets that are the other divided data sets that are stored in the storage medium without being encrypted, and
the encrypted key data sets stored in the storage medium, the encrypted key data sets corresponding to the respective encrypted data sets and the respective non-encrypted data sets; and
the decryption portion is configured in such a manner
that when a first one of the encrypted key data sets and a first one of the encrypted data sets have been read from the storage medium, the decryption portion decrypts the first encrypted key data set and the first encrypted data set based on one of the key data sets that is retained in the key-data retention portion, and then outputs a first one of the divided data sets and a first one of the key data sets,
that when the first encrypted key data set and a first one of the non-encrypted data sets have been read from the storage medium, on the other hand, the decryption portion decrypts the first encrypted key data set based on another one of the key data sets that is retained in the key-data retention portion, and then outputs the first key data set, and
that the decryption portion decrypts, based on the first key data set, a second one of the encrypted key data sets, or the second encrypted key data set and a second one of the encrypted data sets, read following on the first encrypted key data set and the first encrypted data set, or following on the first encrypted key data set and the first non-encrypted data set.

4. The data processing device of claim 1, wherein
the read-control portion is configured so as to successively read, in a uniquely determined manner,
the encrypted data sets that are said encrypted ones of the plurality of divided data sets stored in the storage medium,
non-encrypted data sets that are the other divided data sets that are stored in the storage medium without being encrypted, and
the encrypted key data sets stored in the storage medium, the encrypted key data sets corresponding to the respective encrypted data sets; and
the decryption portion is configured in such a manner
that when a first one of the encrypted key data sets and a first one of the encrypted data sets have been read from the storage medium, the decryption portion decrypts the first encrypted key data set and the first encrypted data set based on one of the key data sets that is retained in the key-data retention portion, and then outputs a first one of the divided data sets and a first one of the key data sets, and
that the decryption portion decrypts, based on the first key data set, a second one of the encrypted key data sets and a second one of the encrypted data set sets read after the first encrypted key data set and the first encrypted data set.

5. The data processing device of claim 1, wherein
the read control portion is configured
so as to read, after reading a first one of the encrypted data sets stored in the storage medium, a second one or any one of second ones of the encrypted data sets which have each been determined beforehand to correspond to the first encrypted data set, and which form a possible-successor group, and
so as to read, in relation to the first encrypted data set, an encrypted-key-data group that includes one or more of the encrypted key data sets which have been obtained by encrypting one or more of the key data sets, the one or more key data sets being used for decrypting the second encrypted data set or sets forming the possible-successor group;
the key-data retention portion retains the one or more key data sets that have been decrypted from the one or more encrypted key data sets forming the encrypted-key-data group that has been read from the storage medium; and
the decryption portion is configured so as to decrypt, based on one key data set that is included among the one or more key data sets retained in the key-data retention portion and that corresponds to the second encrypted data set that has been actually read following on the first encrypted data set, the second encrypted data set and at least one of the encrypted key data sets which has been read in accordance with the second encrypted data set, and which forms an encrypted-key-data group.

6. The data processing device of claim 1, wherein the data to be stored in the storage medium includes instructions that the data processing device is made to execute, and branch instructions included among those instructions determine a sequence of reading the encrypted data sets.

7. A data processing device which reads and decrypts encrypted data sets and encrypted key data sets stored in a storage medium, the encrypted data sets being obtained by dividing to-be-stored data into a plurality of divided data sets and then encrypting at least some of the divided data sets for decryption by respectively different key data sets, the encrypted key data sets being obtained by encrypting the key data sets for decryption by a common key data set, the data processing device comprising:
a read-control portion for controlling reading of each said encrypted data set and each said encrypted key data set;
a decryption portion for decrypting the encrypted data set and the encrypted key data set that have been read under the control of the read-control portion; and
a key-data retention portion that retains the common key data set, and one of the key data sets decrypted from the encrypted key data set by the decryption portion,
wherein the decryption portion is configured so as to decrypt the encrypted data set and the encrypted key data set based on one of the key data sets or the common key data set retained in the key-data retention portion.

8. The data processing device of claim 7, wherein
the key data retention portion includes a first key-data retention portion for retaining the key data set decrypted from the encrypted key data set, and a second key data-retention portion for retaining the common key data set; and
the decryption portion includes a first decryption portion for decrypting the encrypted data set based on the key data set retained in the first key data retention portion, and a second decryption portion for decrypting the encrypted key data set based on the common key data set retained in the second key data retention portion.

9. The data processing device of claim 8, further comprising a dummy-read-signal outputting portion that outputs a signal to the storage medium during the period in which the second decryption portion decrypts the encrypted key data set, the signal being the same as a signal for reading a data set stored in an area different from an area in which a data set that will be read next is stored.

10. A data processing method, in which encrypted data sets and encrypted key data sets stored in a storage medium are read and decrypted, the encrypted data sets being obtained by dividing to-be-stored data into a plurality of divided data sets and then encrypting at least some of the divided data sets for decryption by respectively different key data sets, each of the encrypted key data sets being obtained by encrypting each said key data set for decryption by any one of the other key data sets, the data processing method comprising the steps of:
(a) reading one of the encrypted data sets and one of the encrypted key data sets; and
(b) decrypting said one encrypted data set and said one encrypted key data set that have been read in the step (a), and then making a key-data retention portion retain one of the key data sets that has been decrypted from said one encrypted key data set;
wherein in the step (b), said one encrypted data set and said one encrypted key data set are decrypted based on one of the key data sets that has already been retained in the key-data retention portion.

11. A data processing method, in which encrypted data sets and encrypted key data sets stored in a storage medium are read and decrypted, the encrypted data sets being obtained by dividing to-be-stored data into a plurality of divided data sets and then encrypting at least some of the divided data sets for decryption by respectively different key data sets, the encrypted key data sets being obtained by encrypting the key data sets for decryption by a common key data set, the data processing method comprising the steps of:
(a) reading one of the encrypted data sets and one of the encrypted key data sets; and
(b) decrypting said one encrypted data set and said one encrypted key data set that have been read in the step (a), and then making a key-data retention portion retain one of the key data sets that has been decrypted from said one encrypted key data set;
wherein in the step (b), said one encrypted data set and said one encrypted key data set are decrypted based on one of the key data sets or the common key data set that has already been retained in the key-data retention portion.
